(19) United States
(12) Patent Application Publication
(10) Pub. No.: US 2010/0304697 A1
(43) Pub. Date: Dec. 2, 2010

(54) APPARATUS AND METHOD FOR RECEIVING BROADCAST INFORMATION USING ZIP CODE

(75) Inventor: Seongho Yoon, Seoul (KR)

Correspondence Address: HAMRE, SCHUMANN, MUELLER & LARSON, P.C., P.O. BOX 2902, MINNEAPOLIS, MN, 55402-0902, US

(73) Assignee: Namsung Co., Ltd., Seoul (KR)

(21) Appl. No.: 12/471,739

(22) Filed: May 26, 2009

(51) Int. Cl. H04B 1/18

(52) U.S. Cl. 455/186.1

(57) ABSTRACT

Disclosed is an apparatus and method for receiving broadcast information using a zip code for automatically setting broadcast frequency based on the zip code. The apparatus for receiving broadcast information using a zip code comprises: an input unit that inputs reservation codes and zip codes to store broadcast information; a controller that controls to store reservation information on the broadcast information in a storage unit, based on the reservation codes from the input unit and a stored broadcast schedule, updates the reservation information based on the zip codes from the input unit, and stores the broadcast information corresponding to the reservation information; and a recording/reproducing unit that stores the broadcast information in the storage unit according to the control of the controller.

### BACKGROUND OF THE INVENTION

1. Field of the Invention

The present invention relates to an apparatus and method for receiving broadcast information using a zip code, and more specifically, to an apparatus and method for receiving broadcast information for setting broadcast frequencies according to zip codes.

2. Description of the Related Art

In general, a radio is a device that receives broadcast signals of broadcast channels in question according to the broadcast channels selected by a user and outputs the broadcast signals by voice. Each broadcasting station uses different broadcasting frequencies to transmit broadcasting signals. Further, even the same broadcasting station uses different broadcast frequencies for each geographical area to transmit the broadcast signals.

When a user wants to listen to a broadcast output from a radio mounted in a vehicle, while the vehicle is moving in various geographical areas, the broadcast signal from the corresponding broadcast channel to which the user is listening may not be received completely due to a change of geographical area. Thereby, noise may be generated in the broadcast signal or it is impossible to receive the broadcast signal. In this case, the user should manually select the broadcast channel corresponding to a current geographical area.

Further, even in the above-mentioned case, the user can easily select the broadcast channel only when he/she positively know the broadcast frequencies for each geographical area of each broadcasting station. Of course, there is a case where the vehicle includes a function of automatically searching the receivable broadcast frequencies. Even in this case, however, the user should search the receivable broadcast frequencies. In other words, the broadcast frequency of the broadcast channel to which the user is listening should be changed according to the change of the geographical area. However, it cannot be automatically searched the changed broadcast frequencies of the broadcast channel to which he/she is listening. Therefore, in order for the user to listen to the broadcast on the same broadcast channel, there is a problem in that he/she should select the broadcast frequency of the corresponding broadcast channel whenever there is change in geographical area.

Moreover, in a radio providing the reservation storing function, when the user moves a predetermined distance after reserving the storage of the broadcast information at any one place, there may be the case where the broadcast frequencies and the broadcasting hours of the corresponding geographical area are changed. In this case, the broadcast information is stored according to the existing broadcast frequency, not the changed broadcast frequency. As a result, the broadcast information including a lot of noise is stored. In some cases, only the noise is stored rather than the broadcast information. The broadcast information is stored according to the existing broadcasting hours, not the changed broadcasting hours. Accordingly, there is a problem in that only a portion of broadcast information or unnecessary broadcast information is stored.

### SUMMARY OF THE INVENTION

The present invention proposes to solve the problems of the related art. It is an object of the present invention to provide an apparatus and method for receiving broadcast information using a zip code to automatically set broadcast frequency based on the zip code.

It is another object of the present invention to provide an apparatus and method for receiving broadcast information using a zip code to store broadcast information in question according to reservation information changed by updating the reservation information for the broadcast information based on the zip code.

In order to achieve the above objects, there is provided an apparatus for receiving broadcast information using a zip code according to an embodiment of the present invention, comprising: an input unit that inputs reservation codes and zip codes to store broadcast information; a controller that controls to store reservation information of the broadcast information in a storage unit, based on the reservation codes from the input unit and a stored broadcast schedule and to store the broadcast information corresponding to the reservation information and updates the reservation information based on the zip codes; and a recording/reproducing unit that stores the broadcast information in the storage unit according to the control of the controller.

The controller can switch the broadcast frequency to the broadcast frequency corresponding to the geographical area in question by inputting the zip code.

The controller detects broadcasting hours and broadcast frequencies corresponding to the reservation codes from the stored broadcast schedule and stores them together with the reservation codes as the reservation information.

The storage unit further stores the broadcast frequencies for each zip code including the broadcast frequencies changed according to the zip codes.

The controller updates the reservation information stored in the storage unit based on the zip codes and the broadcast frequencies for each geographical area stored in the storage unit.

Further, there is provided an apparatus for receiving broadcast information using a zip code, comprising: an input unit that inputs reservation codes to store broadcast information; a position detector that detects positional information of the apparatus for receiving broadcast information; a zip code detector that detects zip codes based on the positional information from the position detector; a controller that controls to store reservation information on the broadcast information in a storage unit, based on the reservation codes from the input unit and a stored broadcast schedule and to store the broadcast information corresponding to the reservation information and updates the reservation information based on the zip codes from the zip code detector; and a recording/reproducing unit that stores the broadcast information in the storage unit according to the control of the controller.

The controller controls to switch a channel to the broadcast frequencies corresponding to the geographical areas in question when the zip codes are input.

The controller detects broadcasting hours and broadcast frequencies from the stored broadcast schedule and stores them together with the reservation codes as the reservation information.

The storage unit further stores the broadcast frequencies for each zip code including the broadcast frequencies changed according to the zip codes.

The controller updates the reservation information stored in the storage unit based on the zip codes and the broadcast frequencies for each geographical area stored in the storage unit.

In order to achieve the above objects, there is provided a method for receiving broadcast information using a zip code through an apparatus for receiving broadcast information according to an embodiment of the present invention, comprising: (a) storing reservation information on the broadcast information based on input reservation codes and a stored broadcast schedule; (b) updating the reservation information stored at step (a) based on the input zip code; and (c) storing the broadcast information based on the reservation information updated at step (b).

Step (a) detects broadcasting hours and broadcast frequencies corresponding to reservation codes from the broadcast schedule and stores them together with the reservation codes as the reservation information.

Step (b) updates the reservation information based on, zip codes and information on broadcasting stations for each zip code.

Step (a) includes (a-1) receiving the reservation codes to reserve and store the broadcast information.

Step (b) includes (b-1) receiving zip codes to update the reservation information.

Step (b) includes (b-2) detecting positional information of the apparatus for receiving broadcast information; and (b-3) detecting zip codes corresponding to the position information detected at step (b-2).

With the present invention, the apparatus and method for receiving broadcast information using a zip code stores the corresponding information according to the reservation information changed by updating the reservation information on the broadcast information based on the zip code, thereby making it possible to store the broadcast information without noise and accurately store only the desired broadcast information.

### BRIEF DESCRIPTION OF THE DRAWINGS

FIG. 1 is a block diagram for explaining a configuration of an apparatus for receiving broadcast information using a zip code according to a first embodiment of the present invention;

FIG. 2 is a flow chart for explaining a method for receiving broadcast information using a zip code according to the first embodiment of the present invention;

FIG. 3 is a block diagram for explaining a configuration of an apparatus for receiving broadcast information using a zip code according to a second embodiment of the present invention; and

FIG. 4 is a flow chart for explaining a method for receiving broadcast information using a zip code according to the second embodiment of the present invention;

### DESCRIPTION OF THE PREFERRED EMBODIMENTS

Hereinafter, the most exemplary embodiments of,the present invention will be described in detail with reference to the accompanying drawings so that those skilled in the art can easily practice the technical ideas of the present invention. In adding reference numerals to components throughout the drawings, like reference numerals refer to like elements although maybe shown differently in other drawings. Further, the detailed description of a related known function or configuration that may make the purpose of the present invention unnecessarily ambiguous in describing the present invention will be omitted.

Prior to describing the exemplary embodiments according to the present invention, terms used for explaining the exemplary embodiments of the present invention is defined as follows.

Broadcast information means a broadcast program consisting of one content or a plurality of contents provided from a broadcasting station.

A broadcast schedule is information provided to listeners, including broadcasting hours, broadcast frequencies, reservation codes, and the like, regarding a plurality of broadcast information. The broadcast schedule may be different according to the broadcasting stations. The broadcast schedule may be different for each geographical area even in the same broadcasting station.

A reservation code, which is information generated according to the broadcast schedule, is a unique code established in each of the broadcast information organized in the broadcast schedule. At this time, the reservation code is established to be the same even if the broadcast information is differently organized in terms of the broadcast schedule according to a geographical area. A unique reservation code is established to identify broadcast information provided from all the broadcasting stations.

Reservation information means broadcast information to be reserved and stored. The reservation information includes reservation codes input by a user and broadcasting hours and broadcast frequencies of the broadcast information, which correspond to the reservation codes.

A zip code is a unique code for identifying a corresponding geographical area (for example, city). At this time, the zip codes for each area are different from each other.

A broadcast frequency for each geographical area code is a broadcast frequency in which one can listen to the broadcast within that geographical area. In other words, the broadcast frequency for each geographical area code is information that assigns zip codes of each geographical area (for example, a ZIP CODE) with broadcast frequencies in which the broadcast in the corresponding geographical area can be listened thereto. At this time, the frequencies of the broadcast in order to listen to the same broadcast in different geographical areas may be different. For example, as described in the following table 1, in the case of broadcasting station A, the broadcast frequency is 89.1 MHz in city A, 98.5 MHz in city B, 92.3 MHz in city C, and 89.7 MHz in city D.

TABLE 1

| | | Broadcast |
|---|---|---|
| Geographical area | Zip Code | Frequency |
| City A | 77004 | 89.1 |
| City B | 77074 | 98.5 |
| City C | 77091 | 92.3 |
| City D | 77094 | 89.7 |

### First Embodiment

Hereinafter, a first exemplary embodiment of an apparatus for receiving broadcast information using a zip code according to the present invention will be described with reference to the accompanying drawings.

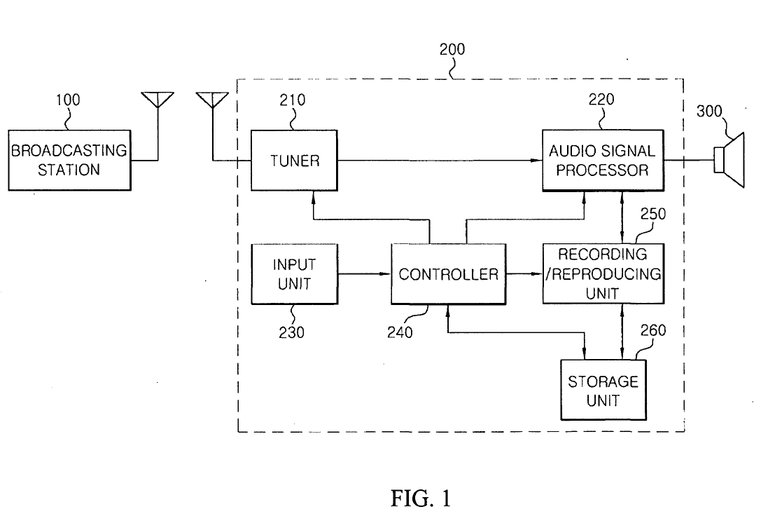

FIG. 1 is a block diagram for explaining a configuration of an apparatus for receiving broadcast information using a zip code according to a first embodiment of the present invention.

As shown in FIG. 1, an apparatus 200 for receiving broadcast information using a zip code includes a tuner 210, an audio signal processor 220, an input unit 230, a controller 240, a recording/storing unit 250, and a storage unit 260.

The tuner 210 tunes the frequencies of broadcast channels according to control signals of the controller 240.

The audio signal processor 220 processes signals by voice so that a listener can listen to broadcast information received in the tuner 210 and outputs it through a speaker 300.

The input unit 230 inputs control information for controlling an operation of the receiving apparatus 200. In other words, the input unit 230 inputs the control information for controlling the operation of the apparatus for receiving broadcast information, such as turning on/off a power supply, recording, changing a channel, reproducing, setting, and the like.

The input unit 230 inputs reservation codes corresponding to the broadcast information to be recorded by a listener. In other words, the listener operates the input unit 230 based on a broadcast schedule provided from the broadcasting station 100 and inputs the reservation codes corresponding to the broadcast information when he/she wants to record.

The input unit 230 inputs zip codes corresponding to a geographical area in which the apparatus 200 for receiving broadcast information is located. In other words, the input unit 230 inputs zip codes that corresponding to geographical areas when the zip codes are changed while the apparatus 200 for receiving broadcast information is moving.

The input unit 230 is configured of a plurality of buttons, including a power supply turning-on/off button, a reproducing button, a recording button, a channel up/down button, a preset button, and the like.

The controller 240 controls the storage unit 260 to store the broadcast schedule received from the broadcasting station 100 through the tuner 210. In other words, the controller 240 controls the storage unit 260 to store the broadcast schedule including reservation codes, broadcast frequencies, broadcasting hours for the broadcast information from the broadcasting station 100. Herein, the controller 240 updates the stored broadcast schedule to a new broadcast schedule when the broadcast schedule is stored in the storage unit 260.

The controller 240 stores the reservation information for the corresponding broadcast information in the storage unit 260 based on the reservation code from the input unit 230. In other words, the controller 240 detects the broadcasting station name, the broadcast hours, and the broadcast frequencies, which correspond to the broadcast information having the same reservation codes as the reservation codes from the input unit 230, from the broadcast schedule stored in the storage unit 260. The controller 240 assumes the detected broadcasting station name, broadcast hours, and broadcast frequencies to be the reservation information and stores them together with the reservation codes in the storage unit 260.

The controller 240 updates the broadcast schedule and the reservation information stored in the storage unit 260 based on the reservation code from the input unit 230. In other words, the controller 240 detects the broadcast frequencies, which corresponds to the same zip codes as the zip codes from the input unit 230, from the broadcast frequencies for each zip code stored in the storage unit 260. The controller 240 updates the broadcast frequencies of the reservation information stored in the storage unit 260 to the previously detected broadcast frequencies. Herein, the controller 240 receives a new broadcast schedule from the broadcast station 100 when the broadcast information broadcasted according to the zip codes is changed and updates the broadcast schedule stored in the storage unit 260. As such, the apparatus and method for receiving broadcast information using a zip code updates the reservation information for the broadcast information based on the zip codes and stores the corresponding broadcast information according to the changed reservation information, thereby making it possible to store the broadcast information without noise and accurately store only the desired broadcast information.

The controller 240 controls to store the broadcast information based on the reservation information stored in the storage unit 260. In other words, the controller 240 records the broadcast information by controlling the tuner 210, the audio signal processor 220, and the recording/reproducing unit 250 based on the reservation information stored in the storage unit 260 when the reserved broadcast information is transmitted. Herein, the controller 240 turns on the power supply when the power supply of the apparatus 200 for receiving broadcast information is turned off and then, proceeds the recording of the selected type of broadcast information.

The controller 240 controls to reproduce the recorded broadcast information based on the control information from the input unit 230. In other words, the controller 240 controls the reproducing unit 250 and the audio signal processing unit 220 based on the control information from the input unit 230 and reproduces the recorded broadcast information.

The controller 240 controls to switch the broadcast frequency, which is being reproduced, to the broadcast frequency corresponding to the inputted zip code based on the zip code inputted through the input unit 230. In other words, the controller 240 controls the tuner 210 and the audio signal processor 220 to switch the broadcast frequency corresponding to the broadcast channel, which is being reproduced, to the broadcast frequency in the geographical area corresponding to the inputted zip code based on the zip code inputted through the input unit 230. More specifically, the controller 240 controls the tuner 210 and the audio signal processors 220 so as to receive the broadcast information from the broadcast channel (that is, broadcast station) selected by the user and reproduce it in real time. The controller 240 controls the tuner 210 and the audio signal processors 220 so as to switch the broadcast frequency of the broadcast channel, which is being reproduced, to the broadcast frequency in the geographical area corresponding to the inputted zip code when the zip code is inputted through the input unit 230.

The recording/reproducing unit 250 records and reproduces the broadcast information according to the control of the controller 240. Herein, the contents regarding the method for recording, storing, and reproducing the broadcast information and the configuration of the recording/reproducing unit 250 can be easily understood by those skilled in the art and therefore, the detailed description thereof will be omitted.

The storing unit 260 stores the broadcast frequencies for each zip code for the broadcast station 100. In other words, the storing unit 260 stores the broadcast frequencies for each zip code in a lookup table form illustrated in Table 1. The broadcast frequencies for each zip code for the broadcast station 100 stored in the storing unit 260 can be updated. In the above description, the broadcast frequency for each zip code is stored in the lookup table form, but any other form capable of matching the zip code with the broadcast frequency may be permitted.

The storing unit 260 further stores the schedule information, the reservation information, and the broadcast information other than the broadcast frequencies for each zip code for the plurality of broadcasting stations. In other words, the storage unit 260 stores the broadcast schedule including the reservation codes, the broadcast hours, and the broadcast frequencies, etc., for the plurality of broadcast information. The storage unit 260 stores the reservation information for the broadcast information. The storage unit 260 stores the broadcast information corresponding to the reservation information.

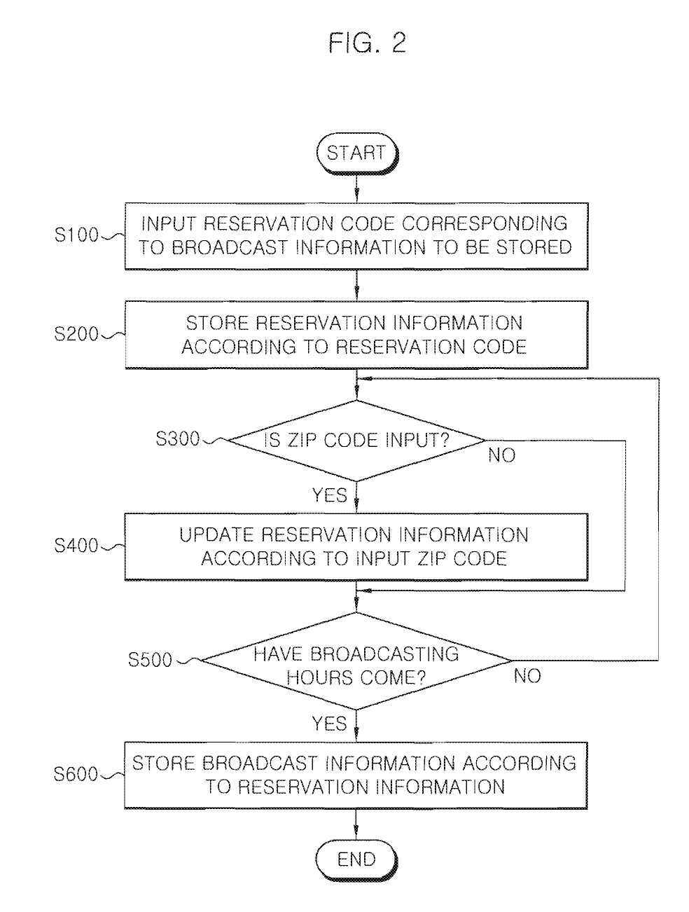

FIG. 2 is a flow chart for explaining a method for receiving broadcast information using a zip code according to the first embodiment of the present invention. In order to facilitate the description of the method for receiving broadcast information according to the first embodiment of the present invention, it is assumed that the apparatus 200 for receiving broadcast information is mounted on a vehicle. The storing unit 260 stores the broadcast frequencies for each zip code. The storing unit 260 receives and stores the broadcast schedule from the broadcast station 100.

The input unit 230 inputs the reservation code corresponding to the broadcast information to be stored (S100). In other words, the listener operates the input unit 230 configured of a plurality of buttons according to the broadcast schedule provided from the broadcast station 100 and inputs the reservation code of the broadcast information to be stored.

The controller 240 stores the reservation information for reserving and storing the corresponding broadcast information in the storage unit 260 based on the reservation code from the input unit 230 (S200). In other words, the controller 240 detects the broadcast information, which has the same reservation codes as the reservation codes from the input unit 230, from the storage unit 260. The controller 240 detects the broadcast hours and broadcast frequencies from the detected broadcast schedule. The controller 240 assumes the previously detected broadcast hours and broadcast frequencies to be the reservation information and stores them together with the reservation codes in the storage unit 260.

The geographical area in which the apparatus 200 for receiving broadcast information is located is changed due to the vehicle moving. In other words, a geographical area in which the apparatus 200 for receiving broadcast information is currently located is different from a geographical area reserving the storage of the broadcast information. As a result, the input unit 230 inputs a zip code corresponding to the new geographical area (S300). In other words, the listener inputs the zip code corresponding to the geographical area in which the apparatus 200 for receiving broadcast information is currently located by operating the input unit 230 when the geographical area is changed.

If the zip code is inputted from the input unit 230 (S300: YES), the controller 240 updates the reservation information stored in the storage unit 260 based on the zip code inputted from the input unit 230. In other words, the controller 240 detects the broadcast frequencies, which correspond to the same zip codes as the zip codes from the input unit 230, from the broadcast frequencies for each zip code stored in the storage unit 260. The controller 240 updates the broadcast frequencies of the reservation information stored in the storage unit 260 to the broadcast frequencies for each detected zip code. Herein, the controller 240 receives a new broadcast schedule from the broadcast station 100 when the broadcast information broadcasted according to the zip codes is changed and updates the broadcast schedule stored in the storage unit 260. As such, the apparatus 200 and method for receiving broadcast information using a zip code updates the reservation information for the broadcast information based on the zip codes and stores the corresponding broadcast information according to the changed reservation information, thereby making it possible to store the broadcast information without noise and accurately store only the desired broadcast information.

If the broadcast hours of the broadcast information corresponding to the reservation information stored in the storage unit 260 comes (S500: YES), the controller 240 controls the tuner 210, the audio signal processor 220, and the recording/reproducing unit 250 to store the broadcast information in the storage unit 260 (S500). The tuner 210 tunes the corresponding broadcast frequency based on the reservation information stored in the storage unit 260. As a result, the broadcast information received through the tuner 210 is transmitted to the audio signal processor 220. The audio signal processor 220 processes signals by voice so that a listener can listen to broadcast information from the tuner 210. The recording/reproducing unit 250 stores the voice, which is signal-processed in the audio signal processor 220, in the storage unit 260. Thereafter, the listener operates the input unit 230 at a desired time and reproduces and listens to the broadcast information stored in the storage unit 260.

As described above, with the first embodiment of the present invention, the apparatus and method for receiving broadcast information using a zip code updates the reservation information for the broadcast information based on the zip codes and stores the corresponding broadcast information according to the changed reservation information, thereby making it possible to store the broadcast information without noise and accurately store only the desired broadcast information.

However, inputting the zip code of the corresponding geographical area whenever the zip code is changed due to the vehicle moving is inconvenient to the user.

Although the first embodiment of the present invention is described as including one tuner 210, it may include two or more tuners 210 for simultaneously performing the reservation, storage, and listening of the broadcast information.

### Second Embodiment

Hereinafter, a second exemplary embodiment of an apparatus for receiving broadcast information using a zip code according to the present invention will be described with reference to the accompanying drawings.

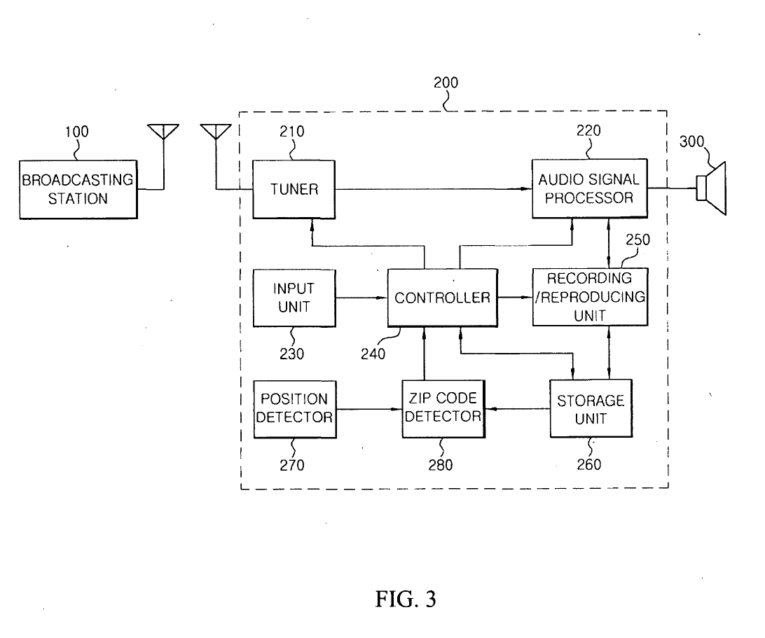

FIG. 3 is a block diagram for explaining a configuration of an apparatus for receiving broadcast information using a zip code according to a second embodiment of the present invention; and

As shown in FIG. 3, the apparatus 200 for receiving broadcast information using a zip code includes the tuner 210, the audio signal processor 220, the input unit 230, the controller 240, the recording/storing unit 250, the storage unit 260, a position detector 270, and a zip code detector 280.

The position detector 270 detects the positional information on a geographical area in which the apparatus 200 for receiving the broadcast information is located. Herein, the position detector 270 uses a GPS device that receives the signals from a GPS satellite and detects a position.

The zip code detector 280 detects the zip code based on the positional information from the position detector 280. In other words, the zip code detector 280 detects the zip code corresponding to the changed geographical area based on the positional information from the position detector 280. The zip code detector 280 transmits the detected zip code to the controller 340. Herein, when the zip code is detected through the position detector 270 and the zip code detector 280, the input unit 230 does not require the zip code corresponding to the changed geographical area.

The tuner 210, the audio signal processor 220, the input unit 230, the controller 240, the recording/storing unit 250, and the storage unit 260 are the same as the configuration of the first embodiment and therefore, the detailed description thereof will not be repeated.

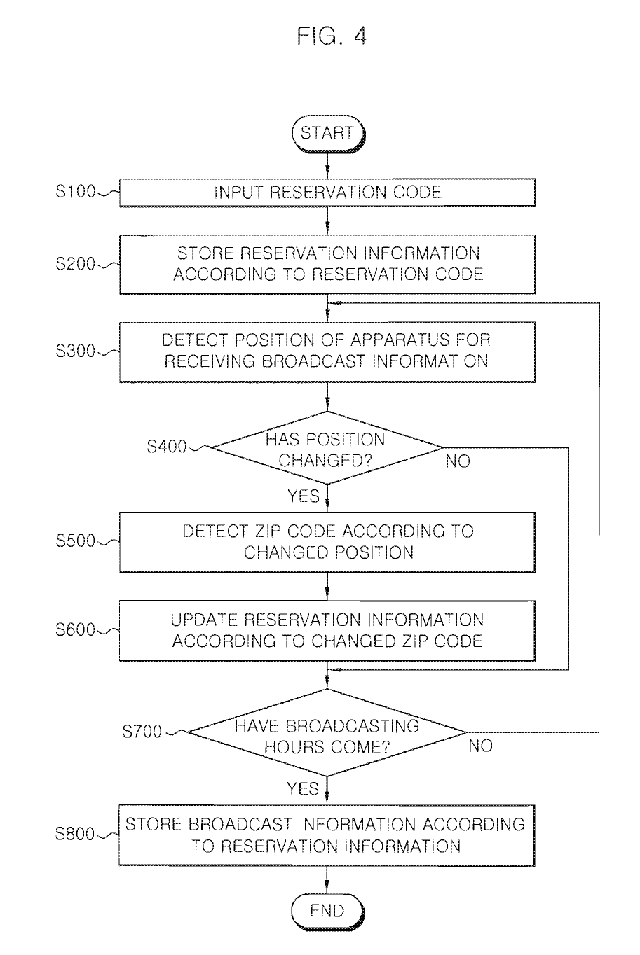

FIG. 4 is a flow chart for explaining a method for receiving broadcast information using a zip code according to the second embodiment of the present invention. In order to facilitate the description of the method for receiving broadcast information according to the embodiment of the present invention, it is assumed that the apparatus 200 for receiving broadcast information is mounted on a vehicle. The storing unit 260 stores the broadcast frequencies for each zip code. The storing unit 260 receives and stores the broadcast schedule from the broadcast station 100.

The input unit 230 inputs the reservation code corresponding to the broadcast information to be stored (S100). In other words, the listener operates the input unit 230 configured of a plurality of buttons according to the broadcast schedule provided from the broadcast station 100 and inputs the reservation code of the broadcast information to be stored.

The controller 240 stores the reservation information for reserving and storing the corresponding broadcast information in the storage unit 260 based on the reservation code from the input unit 230 (S200). In other words, the controller 240 detects the broadcast information, which has the same reservation codes as the reservation codes from the input unit 230, from the storage unit 260. The controller 240 detects the broadcast hours and broadcast frequencies from the detected broadcast schedule. The controller 240 assumes the detected broadcast hours and broadcast frequencies to be the reservation information and stores them together with the reservation codes in the storage unit 260.

The controller 240 controls the position detector 270 to detect whether the apparatus 200 for receiving broadcast information moves. The position detector 270 is configured of GPS and detects the positional information of the apparatus 200 for receiving broadcast information. Herein, the contents of a method for detecting positional information using GPS can be easily understood by those skilled in the art and therefore, the detailed description thereof will not be repeated.

If the geographical area in which the apparatus 200 for receiving broadcast information is positioned is changed (S400: YES), the controller 240 controls the zip code detector 280 to detect the zip code corresponding to the currently located geographical area (S500). The zip code detector 280 detects the zip code corresponding to the currently located geographical area based on the positional information from the position detector 270. The zip code detector 280 transmits the detected zip code 240 to the controller 240. Herein, the contents of detecting the zip code based on the positional information can be easily understood by those skilled in the art and therefore, the detailed description thereof will not be repeated.

The controller 240 updates the reservation information stored in the storage unit 260 according to the zip code from the zip code detector 280 (S600). In other words, the controller 240 detects the broadcast frequency corresponding to the same zip code as the zip code from the zip code detector 280 from the broadcast frequency assigned with each zip code stored in the storage unit 260. The controller 240 updates the broadcast frequencies of the reservation information stored in the storage unit 260 to the previously detected broadcast frequencies. Herein, the controller 240 receives a new broadcast schedule from the broadcast station 100 when the broadcast information broadcasted according to the zip codes is changed and updates the broadcast schedule stored in the storage unit 260. As such, the apparatus 200 and method for receiving broadcast information using a zip code updates the reservation information for the broadcast information based on the zip codes and stores the corresponding broadcast information according to the changed reservation information, thereby making it possible to store the broadcast information without noise and accurately store only the desired broadcast information.

If the broadcast hours of the broadcast information corresponding to the reservation information stored in the storage unit 260 comes (S700: YES), the controller 240 controls the tuner 210, the audio signal processor 220, the recording/reproducing unit 250 to store the broadcast information in the storage unit 260 (S800). The tuner 210 tunes the corresponding broadcast frequency based on the reservation information stored in the storage unit 260. As a result, the broadcast information received through the tuner 210 is transmitted to the audio signal processor 220. The audio signal processor 220 processes signals by voice so that a listener can listen to broadcast information from the tuner 210. The recording/reproducing unit 250 stores the voice, which is signal-processed in the audio signal processor 220, in the storage unit 260. Thereafter, the listener operates the input unit 230 at a desired time and reproduces and listens to the broadcast information stored in the storage unit 260.

As described above, with the second embodiment of the present invention, the apparatus and method for receiving broadcast information using a zip code updates the reservation information for the broadcast information based on the zip codes and stores the corresponding broadcast information according to the changed reservation information, thereby making it possible to store the broadcast information without noise and accurately store only the desired broadcast information.

Further, with the second embodiment of the present invention, the apparatus and method for receiving broadcast information using a zip code automatically inputs the zip code when the geographical area is changed. Therefore, it can solve inconvenience to the user of inputting the zip code of the corresponding geographical area whenever the geographical area is changed.

Although the first embodiment of the present invention is described as including one tuner 210, it may include two or more tuners 210 for simultaneously performing the reservation, storage, and listening of the broadcast information.

As described above, although the present invention has been described with reference to the limited embodiments and accompanying drawings, the present invention is not limited to the embodiments and various changes and modification may be made by those skilled in the art. Therefore, the scope of the present invention should not be limited to the above-described embodiments and should be defined by the appended claims and their equivalents.

What is claimed is:

1. An apparatus for receiving broadcast information using a zip code comprising:
an input unit that inputs reservation codes and zip codes to store broadcast information;
a controller that controls to store a reservation information on the broadcast information in a storage unit based on the reservation codes from the input unit and a stored broadcast schedule, controls to store the broadcast information corresponding to the reservation information and updates the reservation information based on the zip code; and
a recording/reproducing unit that stores the broadcast information in the storage unit according to the control of the controller.

2. The apparatus for receiving broadcast information using a zip code according to claim 1, wherein the controller detects broadcasting hours and broadcast frequencies corresponding to the reservation codes from the stored broadcast schedule and stores them together with the reservation codes as the reservation information.

3. The apparatus for receiving broadcast information using a zip code according to claim 1, wherein the broadcast frequencies for each zip code including the broadcast frequencies changed according to the zip codes is further stored in the storage unit.

4. The apparatus for receiving broadcast information using a zip code according to claim 3, wherein the controller updates the reservation information stored in the storage unit based on the zip codes and the broadcast frequencies for each geographical area stored in the storage unit.

5. The apparatus for receiving broadcast information using a zip code according to claim 1, further comprising an audio signal processor that converts and outputs the broadcast information received over the broadcast frequency tuned by a tuner into a audio signal,
wherein the controller controls to switch the tuned broadcast frequency to the broadcast frequency corresponding to the geographical area in question when the zip code is inputted.

6. An apparatus for receiving broadcast information using a zip code comprising:
an input unit that inputs reservation codes to store broadcast information;
a position detector that detects positional information of the apparatus for receiving broadcast information;
a zip code detector that detects zip codes based on the positional information from the position detector;
a controller that controls to store reservation information on the broadcast information in a storage unit, based on the reservation codes from the input unit and a stored broadcast schedule and controls to store the broadcast information corresponding to the reservation information and updates the reservation information based on the zip codes from the zip code detector; and
a recording/reproducing unit that stores the broadcast information in the storage unit according to the control of the controller.

7. The apparatus for receiving broadcast information using a zip code according to claim 6, wherein the controller detects broadcasting hours and broadcast frequencies corresponding to the reservation codes from the stored broadcast schedule and stores them together with the reservation codes as the reservation information.

8. The apparatus for receiving broadcast information using a zip code according to claim 6, wherein the broadcast frequencies for each zip code including the broadcast frequencies changed according to the zip codes is further stored in the storage unit.

9. The apparatus for receiving broadcast information using a zip code according to claim 8, wherein the controller updates the reservation information stored in the storage unit based on the zip codes and the broadcast frequencies for each geographical area stored in the storage unit.

10. The apparatus for receiving broadcast information using a zip code according to claim 6, further comprising an audio signal processor that converts and outputs the broadcast information received from the broadcast frequency tuned by a tuner into a voice signal,
wherein the controller controls to switch the tuned broadcast frequency to the broadcast frequency corresponding to the geographical area in question when the zip code is inputted.

11. A method for receiving broadcast information using a zip code through an apparatus for receiving broadcast information, comprising:
(a) storing reservation information on the broadcast information based on input reservation codes and a stored broadcast schedule;
(b) updating the reservation information stored at step (a) based on the input zip code; and
(c) storing the broadcast information based on the reservation information updated at step (b).

12. The method for receiving broadcast information using a zip code according to claim 11, wherein step (a) detects broadcasting hours and broadcast frequencies corresponding to reservation codes from the broadcast schedule and stores them together with the reservation codes as the reservation information.

13. The method for receiving broadcast information using a zip code according to claim 11, wherein step (b) updates the reservation information based on zip codes and information on broadcasting stations for each zip code.

14. The method for receiving broadcast information using a zip code according to claim 11, wherein step (a) includes (a-1) receiving the reservation codes to reserve and store the broadcast information.

15. The method for receiving broadcast information using a zip code according to claim 11, wherein step (b) includes (b-1) receiving zip codes to update the reservation information.

16. The method for receiving broadcast information using a zip code according to claim 11, wherein step (b) includes:
(b-2) detecting positional information of the apparatus for receiving broadcast information; and
(b-3) detecting zip codes corresponding to the position information detected at step (b-2).
